(19) United States
(12) Patent Application Publication
(10) Pub. No.: US 2023/0330459 A1
(43) Pub. Date: Oct. 19, 2023

(54) SYSTEM AND METHOD FOR FIGHTING FIRES IN FLAMMABLE LIQUIDS STORED IN ATMOSPHERIC TANKS

(71) Applicant: Moacyr Duarte de Souza Junior, Niteroi (BR)

(72) Inventor: Moacyr Duarte de Souza Junior, Niteroi (BR)

(73) Assignee: Jetfreezr Tecnologia Limitada, Rio de Janeiro (BR)

(21) Appl. No.: 18/010,889

(22) PCT Filed: Sep. 16, 2020
(86) PCT No.: PCT/BR2020/050368

§ 371 Date: Jun. 20, 2023

(30) Foreign Application Priority Data
Jun. 16, 2020 (BR) BR 102020012129.4

(51) Int. Cl. A62C 3/06

(52) U.S. Cl. CPC A62C 3/06

(57) ABSTRACT

A system and method of combating, controlling and extinguishing fires (60) in flammable liquids (65) stored in atmospheric tanks (50), which may comprise low-viscosity materials, the combat being performed by injecting streams of a gaseous extinguishing fluid (16) at ambient conditions, at the bottom of an atmospheric tank (50) through an injector assembly (14), not enabling the formation of residues after the combat of the fire and enabling the fluid (65) to be used normally after the fire has been extinguished. The system does not use water and does not expose people to risks while combating the flames, while minimizing the emission of toxic smoke into the environment and to neighboring populations due to the speed of the combat.

The present invention refers to a system and method of combating, controlling and extinguishing fires in fluids inside atmospheric tanks which may comprise, for example, flammable liquids and/or low-viscosity fuels, the combat consisting of injecting streams of an extinguishing fluid into the bottom of the tank by way of an injector assembly.

### DESCRIPTION OF THE STATE OF THE ART

Low-viscosity flammable liquids are a class that comprises the most strategic and valuable chemical products used throughout the world. As a consequence, tank parks are among the most common installations in the entire world. Even if a country does not possess oil reserves or refinery installations, it must have tank parks to give support to fuel distribution logistics.

Fires in storage tanks are not infrequent events in processing plants, refineries and tank parks. The frequency of fires/explosions in fixed-ceiling tanks containing volatile hydrocarbons has been estimated by Kletz (Kletz, T. A., Hazard Analysis—A Quantitative approach to Safety; Major Loss Prevention; p. 111, 1972) as one in 833 tanks/year. The frequency of the storage tanks with non-flammable products is one tenth of this value.

The most frequent causes of fires/explosions in storage tanks are overflow and atmospheric discharges (Lees, Frank P., Loss Prevention in Process Industries; vol. 2-it:16.11.5,1996). Due to their large capacity (a single tank may contain 150,000 barrels of flammable liquids) and common layout (many tanks in a same containment basin), fires in tanks can easily turn into large-scale accidents. The problem is discussed in the Fire Protection Manual for Hydrocarbons Processing Plants (Vervallin, C. H., Fire Protection Manual for Hydrocarbons Processing Plants, 2nd ed.; 1973) and Kletz (Kletz, T. A., Hazard Analysis—A Quantitative approach to Safety; Major Loss Prevention; p. 111, 1972), among other authors. Experimental studies on fire spread between tanks (Kobori M.; Handa T.; Yumoto T.; Effect of Tank Height on Fire Spread Between Two Model Oil Tanks; Fire Flammability, 12, 157; 1981) have shown how this type of accident can be destructive.

In one technical approach, a fire in a tank can be modeled as a specific type of fire in a well, categorized as “slot fire” (Lees, Frank P., Loss Prevention in Process Industries; vol. 2-it:16.11.5,1996). A fire in a storage tank is like a fire in a circular trench, at a certain height. Experimental studies of a storage tank of internal waves of heat were carried out (Burgoyone J. H.; Ka tan L. L.; Fire in Open Tanks of Petroleum Products: Some Fundamental Aspects; J. Inst. Petrol.; 33; 158; 1947) and (Seeger P. G.; Heat Transfer by Radiation from Fires of Liquid Fuels in Tanks; in Afgan, N and Beer; J. M.; op. ct. p. 431; 1974). Work estimates by Seeger absorbed irradiated energy, considering the “visualization factor”. This factor represents a set of possible directions for heat flow lines, which directly connect the center of irradiation and nearby tanks, considering the incidence angle relative to the surface of the target. This parameter is represented by the angle between the emissive source and a body outside the flame. To calculate the heat radiation, the flame is treated as a vertical or slanted cylinder. Three of the most used models are:
a) Point source model
b) Solid flame model
c) Equivalent radiation model

These models and their applications were described by Crocker and Napier (Crocker W. P.; Napier D. H.; Thermal Radiation of Liquid Pool Fires and Tank Fires; in Hazards IX; p. 159; 1986).

For a point source, the radiation on a surface with a distance “r” from the source is given by the equation (5.1) below:

$$E = \frac{{Q}_{r}}{4 π {r}^{2}}$$

wherein:
E=emissive power of the surface (kW/m²)
Qr=radiated heat (kW)
r=surface radius (cylindrical flame)

Additionally, the radiation incident on the target is given by the equation (5.2) below:

$$I = \frac{α τ {FQ}_{r}}{4 π {I}_{s}^{2}}$$

wherein:
I=Intensity of heat radiation (kW/m²)
α=Absorptivity of the target
τ=Transmissivity of the atmosphere
F=Visualization factor
Is=Slanted distance between the source and the target (m)

Even using the same models, there are some differences between fires in storage tanks and fires in storage compartments, as mentioned previously. According to Lees (Lees, Frank P., Loss Prevention in Process Industries; vol. 2-it:16.11.5,1996), there are four particular differences between fires in compartments and fires in storage tanks:
a) The upper part of the wall of the tank exposed to flame radiation becomes a very hot surface and overheats the flammable fluid (liquid) in contact. This increases vaporization in the zones of the surface of the fluid in contact with a wall of the tank, producing a higher flame. At the same time, this heat transfer (increments the hot layer beneath the surface of the liquid, whereby increasing the burn rate, due to the fact of reducing the variation range of the temperature, necessary for vaporization.
b) The cool fire zone at the base of the flame is protected by the wall of the tank and surrounded by a large heat radiation crown. Using the equations 5.1 and 5.2, according to the specifications of each substance, the emissive power (measured from the heat streams) may rise up to 100 kW/m2 (≅9,000 BTU/ft2.s) or even higher, preventing common extinguishing agents, such as water and foam, from reaching their target (cool fire zone).
c) There is a large volume available for burning from the first moment after ignition. Regular fires in wells would generally increase with the spillage flow and take some time to provide a large volume for burning.
d) Considering the usual layout of tank parks, in the event of fire, there will be other tanks that might catch fire with the heat transferred of the tank which is already in flames. Lois and Swithenbank (Loia E.; Swithenbank J.; Fire Hazard in Oil Tank Arrays in Wind; Combustion 17; p. 1087; 1979) used experiments in wind tunnels to study fire in a series of tanks. These experiments revealed that the control strategies and the potential evolution of a fire in a storage tank depend on the winds at the site. As of a certain speed, the winds alter the directions of the heat streams, deforming the radiation field of the flame.

In this context, there are notably few alternatives known in the state of the art and available to control fires in storage tanks. In fact, there are few actions to be taken after the start of a major fire in the storage tank (API 2021A; Interim Prevention and Suppression of Fire in Large Above Ground Atmospheric Storage Tanks; 1998), namely:
a) Provide cooling on the wall of the tank, with jets of water applied continuously. This practice prevents the walls of the tank from buckling, in the event that the storage tanks are not in conformity with API specifications. Even in this case (API standard tanks), a cooling action should occur to reduce the dimensions of the hot layer below the surface of the liquid.
b) The use of foam in conformity with NPFA 11 (NFPA 11; Standard for Low-, Medium- an High-Expansion Foam; 2005 ed.) is an effective tactic to combat fires, selecting the right type for each product. Using fixed or mobile systems, the foam can be provided with flow rates of up to 2,000 GPM. Fixed injection systems of multipoint and self-expandable foam can be effective, but create a large volume of residues and loss of product.
c) Fixed or mobile water sprayers in systems designed to supply a continuous coating of water on the coverings.
d) Burnout (complete combustion), a practice that consists of leaving the entire content of the tank to burn until the fire extinguishes, with a view to preventing the fire from spreading to the neighboring tanks and equipment and burning them.
e) Removal of the product using regular lower pipes.
f) Foam injection on the surface, consisting of injecting foam just beneath the surface of the liquid through a dedicated fixed line or regular line of products.
g) Foam surface of the very liquid (API 2021A; Interim Prevention and Suppression of Fire in Large Above Ground Atmospheric Storage Tanks; 1998), formed by applying a high-pressure water current on the surface of the hot liquid.

This being the case, the state of the art does not have a system and method of combating, controlling and extinguishing fires in fluids inside storage tanks injecting streams of an extinguishing fluid, gaseous at ambient conditions, at the bottom of the tank through an injector assembly, so as not to contaminate the fluid inside the tank, not lose (waste) its content and to enable said fluid to be used normally after extinguishing the flames.

### Objectives of the Invention

An objective of the present invention is to provide a system and fire-combating method in flammable liquids, in atmospheric tanks.

An objective of the present invention is to provide a system and fire-combating method in flammable fluid (liquid) tanks, that does not contaminate the product inside the tank, not lose (waste) its content and, once the flames are extinguished, enables said fluid to be used normally for its intended purpose before the fire.

An objective of the present invention is to provide a system and fire-combating method in flammable fluid (liquid) tanks by means of an injection of an extinguishing fluid inside the tank that does not produce environmental residues after extinguishment of the fire.

### BRIEF DESCRIPTION OF THE INVENTION

The objectives of the present invention are achieved by means of a system and method of combatting fires in flammable liquid tanks by means of an extinguishing fluid source, a recondensation unit, a vaporization unit, an extinguishing fluid transfer line and an injector assembly, enabling the extinguishing fluid to be injected (inserted) inside the flammable liquid tank from its base. In an embodiment, the injection is maintained until the extinguishing fluid in gaseous state, moving in diffusion through the flammable liquid, emerges inside the tank, combatting the fire from bottom to top, simultaneously throughout the surface area in flames.

### SUMMARY DESCRIPTION OF THE DRAWINGS

The present invention will next be described in detail based on an example of execution represented in the drawings, which show:

FIG. 1—is a representation of a fire dynamic in a storage tank, showing a heat radiation crown and a cool zone of the fire;

FIG. 2—is a representation of an atmospheric tank in flames;

FIGS. 3a and 3b—are representations of a fire in an atmospheric tank and a fire in a storage well (compartment) respectively;

FIG. 4—is a representation of one of the tactics to combat fires in storage tanks known in the state of the art;

FIG. 5—is a representation of foam injection in the subsurface through a fixed system (API 2021A; Interim Prevention and Suppression of Fire in Large Above Ground Atmospheric Storage Tanks; 1998) as in the state of the art;

FIG. 6—is a side view of the system to combat fires according to the teachings of the present invention;

FIG. 7—is a top view of the system to combat fires according to the teachings of the present invention, showing lines and injection nozzles;

FIG. 8—is a representation of an operating principle of the system to combat fires according to the teachings of the present invention, showing an upward stream of bubbles reaching the cool zone of a fire;

FIG. 9—is a side view of the tank, showing a possible embodiment with injectors pointing downward for controlling turbulence.

FIG. 10—is a top view of the tank, showing a possible embodiment with an alternative positioning of injectors, to increase the propagation rate of bubbles;

FIG. 11—is a representation of a possible embodiment of the present invention, showing an arrangement of valves and pipes connected to a fluid transfer line according to the present invention.

### DETAILED DESCRIPTION OF THE DRAWINGS

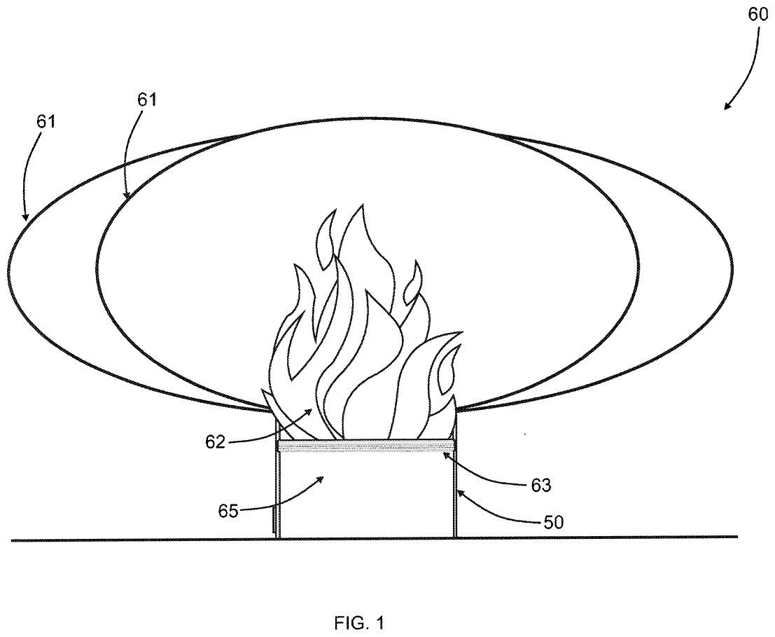

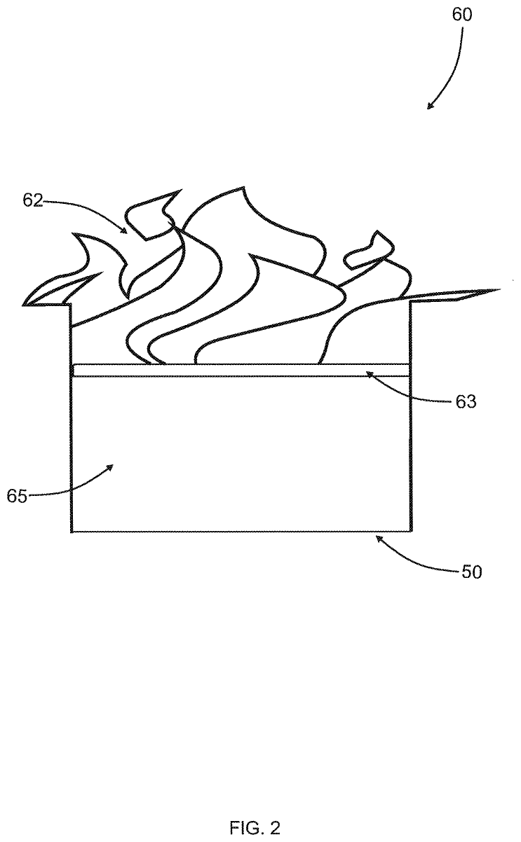

In general, and as exemplified in FIGS. 1 and 2, fires 60 transmit heat to the environment by thermal radiation 61 (heat radiation crown) and have a flame core 62 and a cool fire zone 63, such that fires transmit heat to the environment in their vicinity.

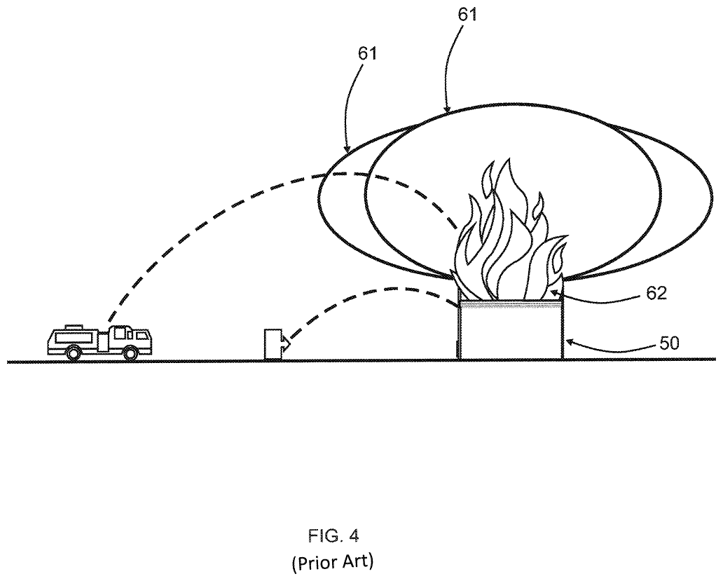

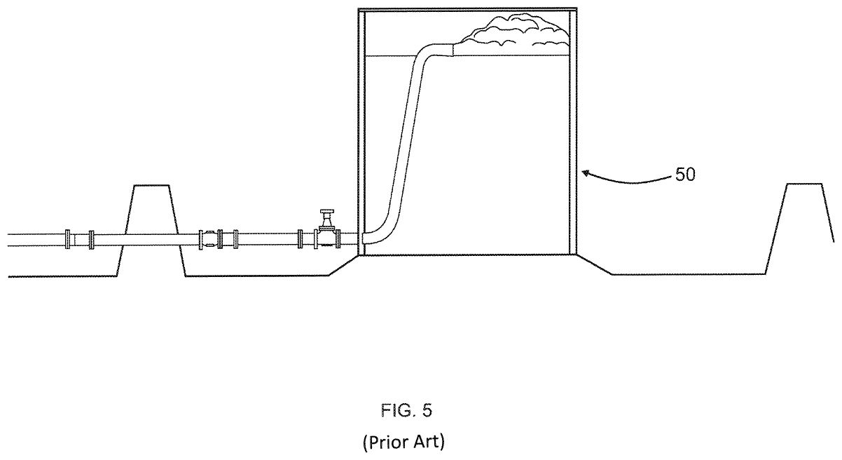

As already mentioned, tactics to combat fires are known in the state of the art, such as, for example, the one illustrated in FIG. 4, in which the fire is combatted by means of external jets of fluids such as water or that illustrated in FIG. 5, which represents the insertion of fluid onto the surface of the liquid in flames.

In reference to FIGS. 1 to 3 and 6 to 11, the present invention refers to a system to combat fires 60 in flammable fluids 65 in atmospheric tanks 50. It should be understood that the flammable fluids 65 to which the present invention refers are preferably liquids which besides being flammable should have specific properties such as, for example, low viscosity.

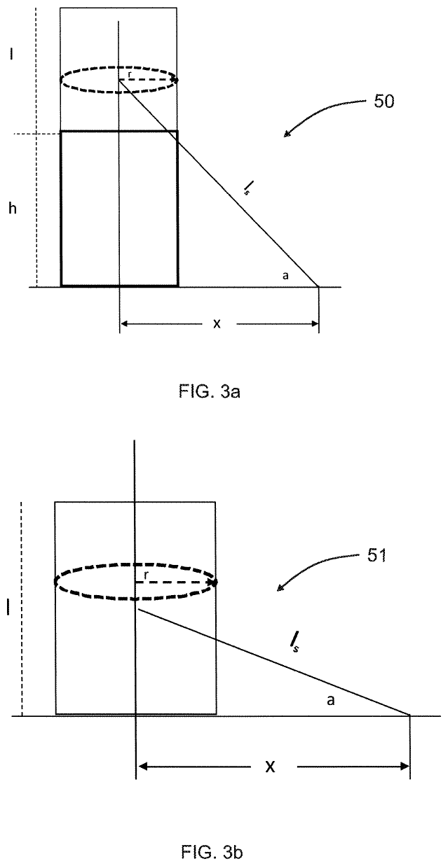

As mentioned, these fluids are stored in atmospheric tanks 50 or specific storage compartments, generally inside large tank parks, industrial plants, production lines or others. It has to be noted that the present invention applies in the same way both to atmospheric tanks 50 or storage compartments 51, which are exemplified respectively in FIGS. 3a and 3b wherein “h” represents the height of the wall of the tank 50, “I” represents the length of the flame core 62, “r” represents a cylindrical flame radius, “Is” represents a slanted distance between a source to combat fires (state of the art) and “a” represents a view factor (slant angle).

Obviously, the storage site should not be understood as a limitation of the invention either, such that to describe the invention, an example of a storage tank 50 will be taken, to the extent that the invention also applies equally to storage compartments 51 or other storage sites, provided they are atmospheric, that is, not pressurized. The type of flammable fluid 65 should not be understood as a limitation of the present invention, since the teachings of same can be applied to different scenarios, provided that due adaptations are made.

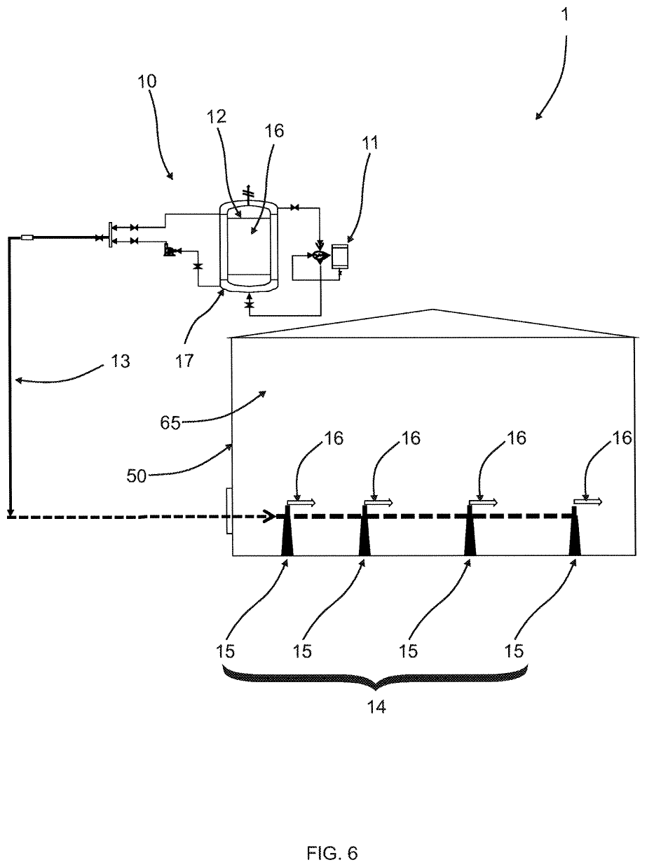

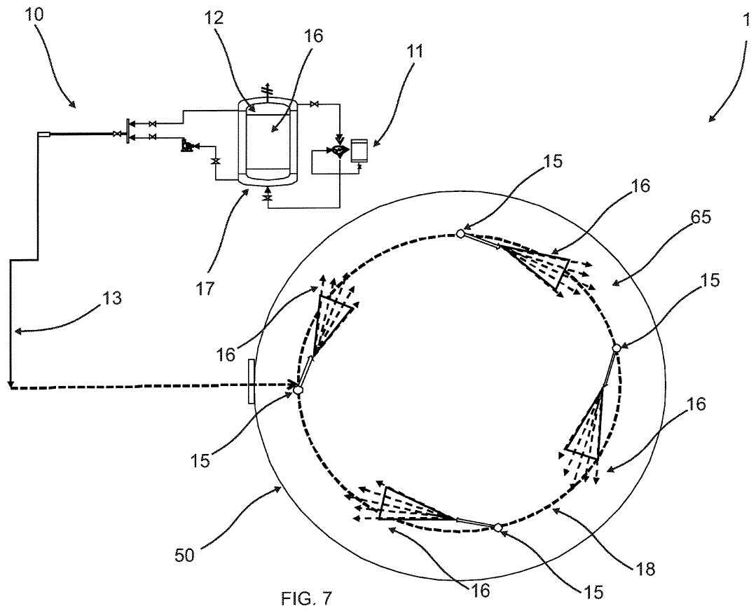

In any case, the system to combat 1 fires 60 in flammable liquids 65 in atmospheric tanks 50 that are the object of the present invention, referred to herein merely as system 1, basically comprises an extinguishing fluid source 10 (fixed or mobile), a recondensation unit 11, a vaporization unit 12 (fixed or mobile), a transfer line (rigid or flexible) for pressurized, liquified extinguishing fluid 13 and an injector assembly 14 fluidly connected to the transfer line of the extinguishing fluid 16, as illustrated especially in FIGS. 6 and 7.

Each one of the components of the system 1 as well as their functions and relationships in the system 1 as a whole will be described in detail ahead.

In order to achieve the objectives of the present invention, the extinguishing fluid is comprised of CO2 in liquid state and CO2 in gaseous state (in a biphasic system), being inert and less dense relative to the content of the tank where it will be applied.

In an embodiment of the present invention, said extinguishing fluid is stored in the main storage tank 10 and subsequently converted into a gaseous phase as soon as it is released inside the atmospheric tank 50 by means of pressurized hoses 13, as shown especially in FIG. 6.

The extinguishing fluid source 10 in turn should be understood as a component arranged like a supplier of the fluid which will combat the flames of the fire in any one of the tanks of a storage park wherein where such comes to occur.

Therefore, said extinguishing fluid source 10 can be understood as a combination comprised by a cryogenic storage tank 17 (fixed or mobile), fluidly coupled to a vaporization unit 12 arranged to maintain the internal pressure of the source tank during the rapid withdrawal of the extinguishing fluid to combat the fire and a recondensation unit 11 arranged to lower the pressure of the source tank in the event of an increase in ambient temperature. Therefore, the extinguishing fluid source 10 is arranged to supply a combatant fluid 16 to the system to combat 1 fires 60.

To maintain the extinguishing fluid 16 in the specific conditions now cited (mixture of liquid and gaseous CO2), the extinguishing fluid source 10 presents an embodiment in which the recondensation unit withdraws gaseous CO2 from the storage tank 17, recondenses it and returns it to the same storage tank 17 in liquid state.

In other words, the gaseous CO2 passes through the recondensation unit 11 where it is liquefied.

This condensation process occurs by means of forced cooling, for example by way of liquid nitrogen. However, other forms of cooling can equally be used.

With this, it is possible to maintain the extinguishing fluid 16 as a biphasic system (liquid/gas) inside the storage tank 17 of the extinguishing fluid.

Additionally, the extinguishing fluid 16 passes through the vaporization unit 12 such that pressure stabilization occurs when the system is driven. This is because in case of said drive, a rapid withdrawal of the liquid phase of the extinguishing fluid 16 occurs, which may lead to the reduction in pressure inside the tank and solidification of the extinguishing fluid. Therefore, the vaporization unit 12 guarantees that said reduction in pressure does not occur, because extinguishing fluid is withdrawn in liquid phase from inside the storage tank 10 and returns it to the very tank in gaseous state, thus being arranged to balance the internal pressure during pumping of the liquefied extinguishing fluid 16 which is sent out of the main reservoir of the system 1.

For example, according to that expounded above, the extinguishing fluid source 10 (fixed or mobile) may present in a possible embodiment of the present invention, the characteristics of which will be described ahead.

It is emphasized that these are described for one example considering a storage tank 17 of 35 tons, cited only as an example of a possible embodiment of the present invention, thus not being a limitation thereof:
a) Storage conditions and transport: Temperature=−20° C.; Pressure between 250 and 300 psig (≅between 17 and 20 bar);
b) Double shielding, with an internal pressure chamber and an external shielding;
c) Made of ASTM-A-612 carbon steel and its design, construction and test must be in conformity with Section VIII, Div. I of ASME;
d) Heat insulation with a layer of expanded polyurethane, perlite under layer of vacuum and coated with fiberglass and resin.
e) The operations of withdrawal and reinsertion of the CO2 can be carried out by way of a liquid CO2 reversible transfer pump, with a flow of 300 GPM, or three pumps of 100 GPM, for transfer pressure of 400 psig and maximum pressure of 500 psig or alternatively, other means can be used, such as a pressurized tank (extinguishing fluid source 10), for example;
f) Electric power source of the pump (if any) and control panel;
g) Vaporization unit arranged to support the withdrawal of the liquid phase of 300 GPM;
h) Gaseous phase withdrawal means.

Before propelling the extinguishing fluid 16 in liquid phase, the transfer line 13 should be previously pressurized with the extinguishing fluid 16 in gaseous phase so that it does not solidify inside said transfer lines 13 and in the injector assembly 14. When the system 1 is driven, that is, when there is a fire in a flammable liquid stored in an atmospheric tank 50 and the system now proposed enters into action, the extinguishing fluid 16 is propelled and conducted along the transfer line 13 up to the injector assembly 14.

To exemplify a possible embodiment of said fluid transfer line 13, it can be made of stainless steel ASTM A-312 TP 304.

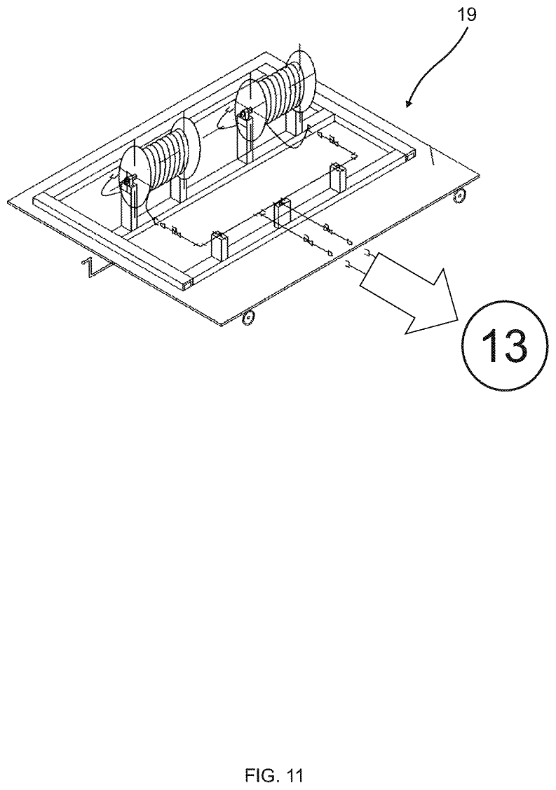

As shown in FIG. 11, an embodiment of the present invention further foresees the use of a specific valve or specific combination of valves 19 in the fluid transfer line 13 and arranged to enable an operator to select the direction of the extinguishing fluid 16, which can be to a specific atmospheric tank 50 inside an installation endowed with various tanks, for example. There may also be a specific valve for controlling an injection of additional CO2 in the fluid transfer line 13. The valves 19 used should meet the standards for cryogenic products, be they manual or automatic.

In any case, the system 1 is arranged to continuously inject (discharge) CO2 under specific pressure and temperature conditions inside the atmospheric tank 50 in which there are flames, to extinguish them.

Accordingly, as cited, after being propelled and conducted along the fluid transfer line 13, the extinguishing fluid reaches the injector assembly 14.

Said injector assembly 14 is comprised of at least one injector nozzle 15 and at least one valve, being positioned inside the atmospheric tank 50 and arranged so that the extinguishing fluid is discharged inside it.

In an embodiment, the injector assembly 14 is positioned inside the atmospheric tank 50, being disposed in a lower portion thereof as exemplified in FIGS. 6 to 10. In a preferred embodiment, lower portion should be understood to mean the bottom of the tank, that is, the injector assembly 14 is positioned inside the atmospheric tank 50, being disposed on the base thereof. More specifically, the injector assembly 14 should be positioned at the bottom of the atmospheric tank 50 so that it actuates even if the tank has little content relative to the nominal capacity. This prevents the injector assembly 14 from being exposed to flames if said atmospheric tank 50 were almost empty at the time of ignition. Moreover, no damage is caused to the walls of the atmospheric tank 50, which could occur if the combination 14 were fixed thereon.

The injector assembly 14, in particular, remains permanently immersed in the flammable liquid 16 inside the atmospheric tank 50.

In a possible embodiment, said injector assembly 14 is mounted on a structure consisting of a double track connected by cross bars, similar to a stairway structure, now referred to as anchorage 18. This structure should be compatible with the atmospheric tank 50 where it is installed, and can be fixed, for example, by screws and flat boards, pressing them against the walls of the atmospheric tank 50.

Said anchorage 18 is arranged to prevent the structure from moving by action of reaction forces when the system now proposed is driven 1. In small tanks (with a radius of up to 7 feet, for example), an inertial mass anchorage can be used.

In an embodiment, the anchorage 18 can be placed inside the atmospheric tank 50 through an inspection door thereof, provided that the lid of the inspection door allows and is designed for such.

To clarify, it is noted that this installation is similar to the way in which vapor lines for supplying heat are placed inside storage tanks of high viscosity oils, so that they can be pumped from one place to another.

All the pipes inside the atmospheric tank 50 should be mounted along the track (anchorage 18) and/or fastened to the cross bars, up to the connection point with the respective injector 15. At the opposite end to the injector 15, the tubes can be connected to flexible lines. These flexible lines can be fastened with screws to the connections mounted on the inner side of the lid of the inspection door.

For safety purposes, it is suggested that all the external pipes be placed in the subsoil and their entry through the inspection door be insulated, for example with a vermiculite lid with concrete. Therefore, the system 1 will not be affected by any of the critical scenarios of damage and malfunctions, such as spillage of flammable liquids 50 caused by an initial explosion, for example.

The injectors 15 of the injector assembly 14 should be understood as an ejector nozzle, arranged so as to maintain the pressure inside the lines. This way, the CO2 in liquid phase can be discharged in the atmospheric tank 50 without passing through a transformation of phase inside the lines, that is, without being transformed into dry ice.

In an embodiment, it is possible to install check valves mounted in sequence before said injectors, to prevent the return of the flammable liquid of the atmospheric tank 50 to inside the extinguishing fluid transfer line 13.

Lastly, an embodiment of the injectors 15 further foresees a lid installed at a distal end of each injector 15, to prevent corrosion thereof. This lid is arranged to be removed instantaneously when the system is driven 1, that is, when the transfer line 13 is pressurized.

In any case, as already mentioned, the injector assembly 14 is positioned inside the atmospheric tank 50 enabling the extinguishing fluid 16 to be discharged inside it.

Since the extinguishing fluid 16 is in a gaseous state, it will have upward movement inside the fluid inside the atmospheric tank 50, the embodiment of the injector assembly 14 as advantageously proposed by the present invention occurs such that the extinguishing fluid 16 emerges in the atmospheric tank 50 when inserted therein.

The extinguishing fluid 16 is discharged in the tank in liquid phase, gaseous phase or mixtures thereof, and the liquid phase solidifies due to the drop in pressure after the injector and should preferably have a ratio of 70% of CO2 solid phase (dry ice) and 30% of CO2 in gaseous state. The immediate sublimation of the dry ice will produce microbubbles of gaseous CO2, increasing the speed of the diffusion of gas in the flammable liquid 65 and at the same time decreasing the turbulence thereof inside the atmospheric tank 50.

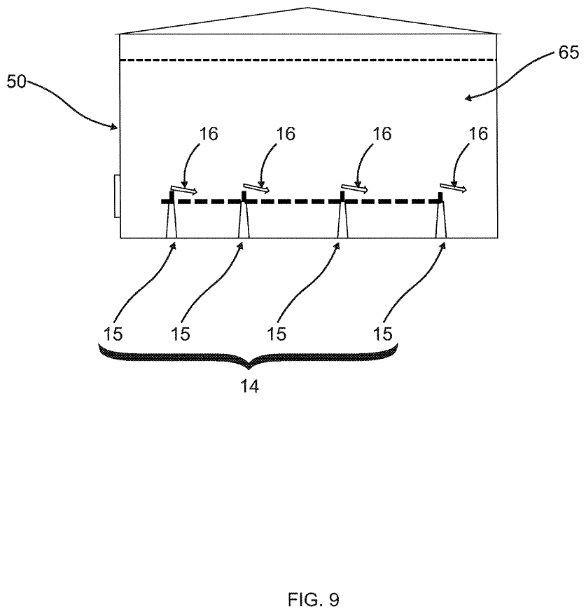

In an embodiment, each injector 15 of the injector assembly 14 can be positioned with a downward vertical slant so as to advantageously control turbulence in the fluid inside the atmospheric tank 50. Thus, a possible slant is between 3° and 10° downward, as can be seen in FIG. 9, which enables this effect to be achieved in the atmospheric tank 50.

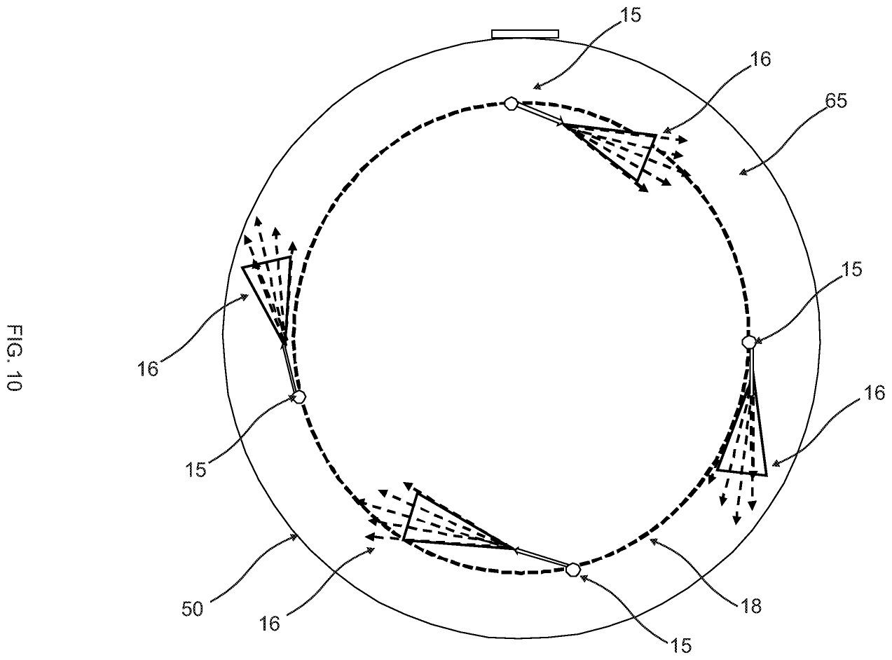

Additionally, with a view to accelerating the dispersion of micro and small bubbles of gaseous CO2, the injectors 15 can be mounted in alternate directions, as exemplified in FIG. 10.

In this embodiment, each injector 15 can be positioned with a slant of 10° for example, towards the center of the atmospheric tank 50 and/or outwardly from the center of the atmospheric tank 50 relative to a tangent of a concentric hypothetical circle to the walls of said tank, enabling the propagation of the extinguishing fluid to accelerate inside said atmospheric tank 50.

This slant can be arranged relative to the tangent of a hypothetical circle that joins the positions of the jet devices inside the atmospheric tank.

Said slants referred to above comprise just one embodiment of the present invention, such that other slants and combinations thereof may also be implemented.

As already mentioned above, the drive of the system 1 now proposed occurs when there is a fire in the fluid stored in an atmospheric tank 50.

Said drive of said system 1 as well as the working thereof aligned with the characteristics described above will be expounded in detail below.

The working of the system 1 basically consists of a continuous injection of a high-pressure stream of extinguishing fluid 16, through the injector assembly 14 positioned preferably at the bottom of the tank.

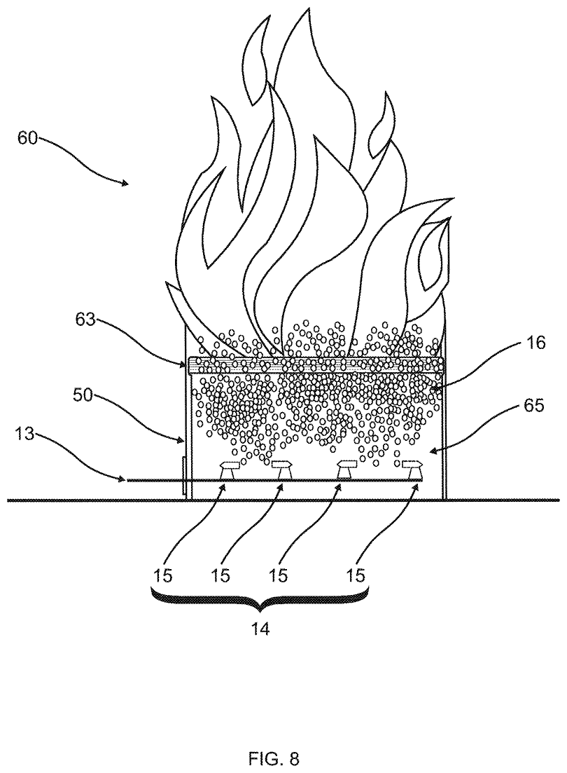

With the insertion of the extinguishing fluid 16 into the atmospheric tank 50 with fluid 65 on the inside, the CO2 contained in said extinguishing fluid 16 will sublimate due to the drop in pressure. The sublimation will form dry ice in the jet, which will undergo a second sublimation (change from solid phase to gaseous phase) causing the formation of micro and small bubbles in the fluid 65 inside the atmospheric tank 50, as illustrated mainly in FIG. 8. The kinetic energy of the jet and the diffusion of CO2 bubbles saturate the low-viscosity flammable fluid 65 in the atmospheric tank 50 and move upward to the surface. Therefore, all the CO2 (extinguishing fluid 16) injected by means of the system will reach the cool fire zone, from bottom to top, that is, the extinguishing fluid 16 will emerge on the surface of the flammable liquid contained in the atmospheric tank 50.

This dynamic has three main effects on the stability of the fire:
a) The mass of CO2 bubbles reaches the surface of the fluid, displacing oxygen from a primary layer where flammable vapors mix with the air (cool fire zone). Maintaining the injection of CO2 for some minutes will extinguish the fire precisely due to the absence of oxygen in that region caused by the CO2, besides the turbulence generated by the gas/liquid diffusion in the subsurface layer of the fluid in flames.
b) The temperature of the dry ice at 1 atm is −78° C. (−108.4° F.). The sublimation of the dry ice provides 245.5 BTU/lb (571.3 KJ/Kg), causing the flammable fluid to cool. Convection movements will decrease the hot layer beneath the surface of the fluid, whereby reducing the vaporization and burn rate (combustion) thereof.
c) The combination of low surface temperature of the fluid and high concentration of CO2 in the primary layer above the surface of the fluid may also prevent the fire from rekindling.

For such, the extinguishing fluid 16 should contain a stream of liquefied CO2, as already mentioned.

It is important to note that an insertion of just a gaseous phase injected into the same flow would cause major turbulence and would have a slower and heterogeneous diffusion, retarding its arrival at the surface of the fluid, which would delay the extinguishment of or would not extinguish the fire with the stock of extinguishing fluid available, due to the fact of not producing a homogeneous concentration of CO2 throughout the surface in flames. The use of the pure gaseous phase would require larger streams and special nozzles to create micro and small bubbles and can be understood as a possible alternative embodiment of the present invention.

For this reason, the present invention preferably suggests that the extinguishing fluid 16 is discharged into the atmospheric tank 50 at a ratio of 70% of CO2 in liquid state (which instantly sublimates into dry ice) and 30% of CO2 in gaseous state, advantageously attaining the objectives now proposed. Alternatively, the present invention can be arranged to produce other distributions of solid and gaseous phases in the composition that is provided by the injector assembly 14 inside the atmospheric tank 50, such as, for example, 40% of gaseous phase and 60% of solid phase, or else 70% of gaseous phase and 30% of solid phase.

The injection of the extinguishing fluid 16 at the bottom of the atmospheric tank 50 begins an intense process of dry ice sublimation (CO2 in solid physical state) formed in the midst of the discharge stream, immediately after its decompression.

This dry ice sublimation occurs with a base temperature of −78° C. and propagation propelled by a jet with pressure between 250 and 290 psi (≅17 and 20 bar) so as to form bubbles grouped inside the atmospheric tank 50, which move emerging towards the surface of the fluid 65. When the CO2 reaches the surface of said fluid 65, the oxygen from the atmosphere which is acting on the combustion of the fluid 65 in flames is displaced to an upper layer, especially due to the greater molecular weight of the extinguishing fluid 16. At the same time, the convection streams inside the fluid disturb the balance of the hot layer under the surface of the fluid 65, advantageously reducing the burn rate in mass thereof.

The system 1 is, therefore, arranged to form a primary layer immediately above the surface of the liquid 65 in flames in the atmospheric tank 50, wherein the primary layer is comprised of CO2 originating from the extinguishing fluid 16.

Commensurate with that described above and in compatibility with the system to combat 1 fires 60 in flammable liquids 65 in atmospheric tanks 50, the present invention advantageously also comprises a fire-combating method in flammable liquids 65 in atmospheric tanks 50.

It should be pointed out that, barring due adaptations, the characteristics of the system to combat 1 fires 60 in flammable liquids 65 in atmospheric tanks 50 already described also apply to the fire-combating method 60 in flammable liquids 65 in atmospheric tanks 50 that are the object of the present invention, that is, it should be understood that the system and method proposed are compatible with each other.

In this context, the fire-combating method 60 in atmospheric fluids 65 in atmospheric tanks 50 occurs by means of an extinguishing fluid source 10, a recondensation unit 11, a vaporization unit 12, a fluid transfer line 13 and an injector assembly 14 fluidly connected to each other.

The characteristics of these components have already previously been described and are equally valid for the fire-combating method in atmospheric tanks 50, that are the object of the present invention.

Specifically, relative to said method, it comprises a series of steps which will be set out in detail ahead.

One step of this method consists of storing an extinguishing fluid 16 on the extinguishing fluid source 10, the extinguishing fluid 16 being comprised of CO2 and inert to the content of the atmospheric tank 50.

This step is arranged so that said extinguishing fluid 16 is stored in liquid and gaseous state, such that the extinguishing fluid is comprised by CO2 in liquid and gaseous state as already mentioned.

One step of the present method comprises extracting the extinguishing fluid 16 from the extinguishing fluid source 10. Put otherwise, the extraction of the extinguishing fluid 16 from said source begins in this step so that it can be conducted to the atmospheric tank 50 with fluid in flames.

Another step of the method, therefore, consists of conducting the extinguishing fluid 16 along the fluid transfer line 13 so that said extinguishing fluid 16 can thus reach the atmospheric tank 50, preserving the biphasic system characteristics with dominance of the liquid phase inside the transfer lines 13, as it was inside the extinguishing fluid source 10.

In any case, the steps of extracting the extinguishing fluid 16 from the extinguishing fluid source 10 and conducting the extinguishing fluid 16 along the fluid transfer line 13 are preferably carried out by means of the pump or, alternatively, by other means as may come to replace the technology available today and be capable of performing the same function inside the system 1.

The pump should be designed to maintain the high pressure on the fluid transfer line 13, pursuant to the necessary transfer load. This way, the length and the diameter of the line and flow used on each project can be used as reference parameters to define the power of the pump and guarantee the ratio of solid and gaseous phase in the jet produced by the injector assembly 14.

These two steps cited above can be understood as an operation selectively comprising triggering control valves to initiate and direct a stream of injection of extinguishing fluid 16 to the atmospheric tank target 50.

The present method may further comprise additional steps of passing the CO2 through the recondensation unit 11 to liquefy the CO2 and also pass the CO2 through the vaporization unit 12 so that pressure stabilization occurs.

It is also a step of the method that is the object of the present invention to discharge the extinguishing fluid 16 inside the atmospheric tank 50. This step is performed by means of the injector assembly 14, and said injector assembly 14 positioned inside the atmospheric tank 50 and installed at the bottom of said tank.

Therefore, after the control valve operation to direct the stream of extinguishing fluid 16, the fluid transmission lines 65 will be pressurized with gaseous phase. When said lines undergo pressure, a lid installed at a distal end of each injector 15 to prevent corrosion thereof is pushed outward (removed) instantaneously, enabling the extinguishing fluid 16 to flow and be injected inside the atmospheric tank 50.

With this, large bubbles will begin to move upward, disturbing the hot layer under the surface of the fluid 65 in flames.

With the gaseous phase of the extinguishing fluid 16 flowing, the pressure inside the fluid transfer line 13 will increase to the point wherein the pressure from said lines becomes equal to the pressure of the extinguishing fluid source 10 and they can retain the CO2 in the liquid phase. When an operator obtains this parameter by means of a manometer, the pumps can be activated to begin the injection of the liquid phase of CO2. At this point, the effect of spreading and cooling the microbubbles will accelerate the process of extinguishing the fire. Put otherwise, the gaseous phase is inserted first to pressurize the fluid transfer line 13, equalizing with the pressure of the tank. After this step, the liquid phase in inserted, which will correspond practically to the totality of the fluid contained in the trigger hose. The gaseous fraction in this step is residual. It is important to emphasize that the liquid content in the fluid transfer line 13 is what enables a high-speed jet to be generated with sublimation. Without this the jet would not have cooling capacity, which is one of the advantageous effects of the system.

More specifically, the extinguishing fluid 16 being less dense than the fluid inside the atmospheric tank 50 enables the step of discharging said extinguishing fluid 16 inside the atmospheric tank 50 to be performed such that said extinguishing fluid 16 emerges in the tank.

In any case, the extinguishing fluid 16 is discharged in the atmospheric tank 50 in liquid phase, gaseous phase or mixtures thereof. In a preferred embodiment, the step of discharging the extinguishing fluid 16 inside the atmospheric tank 50 is arranged so that the extinguishing fluid 16 is discharged into the atmospheric tank 50 at a ratio of 70% of CO2 in liquid state and 30% of CO2 in gaseous state.

Additionally, the step of discharging the extinguishing fluid 16 inside the atmospheric tank 50 is performed by means of the injector assembly 14, and this injector assembly comprises at least one injector 15 and at least one valve.

In line with that already described, it is important to note that an embodiment of the present invention provides for the injector assembly 14 to be positioned with a downward vertical slant so as to control turbulence in the fluid inside the atmospheric tank 50, wherein the downward vertical slant of each injector 15 is from 3° to 10°, for example.

Additionally, the injector assembly 14 can be positioned with a slant towards the center of the atmospheric tank 50 or outward from the center thereof in relation to a tangent of a concentric hypothetical circle to the walls of said tank, so as to accelerate the propagation of the extinguishing fluid inside said atmospheric tank 50 in relation to a tangent of a concentric hypothetical circle to the walls of said tank. In an embodiment, the inward or outward slant of the center of the tank is of the order of 10°, for example.

The discharge flow (injection) of extinguishing fluid 16 and the number of injectors 15 necessary for extinguishing the flames can be defined, for example, based on sizes of the atmospheric tank 50 and on specific characteristics of each flammable liquid such as, for example, its freezing point, viscosity, etc. With the suitable sizing, the response time to combat fires can be very short in atmospheric storage tanks of all sizes and types.

In any case, in an embodiment, the step of discharging the extinguishing fluid 16 inside the atmospheric tank 50 is preferably carried out in two sub steps, one being the injection of CO2 in liquid phase and the other the injection of CO2 in gaseous phase, as already explained previously.

Furthermore, the step of discharging the extinguishing fluid into the atmospheric tank 50 is arranged to form a primary layer immediately above the surface of the liquid in flames in the atmospheric tank 50, wherein this primary layer is comprised at least of CO2 originating from the extinguishing fluid 16.

Some application parameters of the present invention provide highly advantageous in practical and real situations such as, for example, maintaining the injection of CO2 in liquid phase by at least 5 minutes and can extend for 15 minutes depending on the dimensions of the tank.

Once the fire is extinguished, the specifications and properties of the entire fluid (product) originally existing inside the atmospheric tank 50 will not present alterations because the extinguishing fluid is inert thereto.

However, a certain amount of CO2 may have been dissolved in said fluid original 65. Therefore, within 48 to 72 hours, depending on the size of the atmospheric tank 50 and on the viscosity of the fluid 65, all the remaining CO2 injected should return to the atmosphere, as occurs with any carbonated beverage left in an opened bottle.

The CO2 having been eliminated, the fluid 65 in the atmospheric tank 50 which was in flames can be used normally for its original purposes.

For a suitable implementation of the present invention, it is recommendable to have at least three skilled persons, as follows:
a) Head operator—coordinates the fire-combating action;
b) Valve operator—supervisions mainly a correct alignment to direct the injection of the extinguishing fluid 16 to the atmospheric tank 50 in flames.
c) Pump operator—Under the command of the head operator, fire combatting begins by opening the fluid transfer line 13 (especially for application of the gaseous phase), for the alignment previously established. Under the command of the head operator, the pumps are also activated to start the injection of the liquid phase, if there are pumps operating.

If the storage tanks 17 are very near in the same dam, a short injection of extinguishing fluid 16 may be carried out in the nearest atmospheric tanks 50 that are not on fire, in order to avoid the effect of heat radiation. However, it is hardly likely that effect of heat radiation will occur in a prejudicial manner due to the short response time to the application of the present invention.

Some operating parameters related to the present invention are presented below.

The underlying concept for implementing the present invention can be understood as a percolation time of the CO2 gas bubbles in the entire fluid 65, that is, throughout the preferably liquid mass, inside the tank. This time period is not just related to physical and chemical properties of flammable fluids (liquids). The level of the fluid 65 inside the atmospheric tank 50 is a very important parameter, inversely proportional to the time that the CO2 bubbles grouped take to reach the surface of said fluid 65. The lower the level, the quicker the effects of extinguishment should be noted.

To achieve the objectives of the present invention, it is necessary to pump CO2 liquid in a volume equivalent to a hypothetic layer of, for example, ¼ inch over the entire surface of the fluid 65 (flammable liquid) in the atmospheric tank 50.

In this condition, this layer will expand 850 times and will become a layer measuring 212 inches in height. Since CO2 is heavier than the oxygen in the air (combustion), the injection of the extinguishing fluid 16 will drive away all the oxygen available of the surface of the fluid 65. This will happen in addition to the cooling effect and mechanical turbulence in the layer under the surface of said fluid.

The table below shows some parameters related to the present invention considering a cylindrical atmospheric tank 50 as an example:

| | | Injection | CO2 | CO2 |
|---|---|---|---|---|
| Tank radius | Surface area | volume of | flow rate | injection time |
| (ft) | of the fluid (ft²) | CO2 (ft³) | (GPM) | (min) |
| 35 | 3,848.34 | 76,966 | 100 | 6 |
| 65 | 13,272.83 | 265,456 | 200 | 10 |
| 95 | 28,352.03 | 567,040 | 200 | 21 |
| 120 | 45,237.60 | 904,755 | 300 | 22.26 |
| 150 | 70,683.75 | 1,413,663 | 300 | 35.25 |

Considering that set out above, the present invention advantageously proposes a system and method of combating, controlling and extinguishing fires 60 in flammable fluids 65 inside atmospheric storage tanks 17 which may comprise, for example, flammable and/or low-viscosity materials, the combat being carried out by injecting streams of an extinguishing fluid 16 at the bottom of said atmospheric tank 50 through an injector assembly 14, beneficially enabling said fluid 65 to be used normally after the fire has been extinguished by way of the present proposal.

Lastly, in light of that described above, the present invention further comprises an atmospheric tank 50 and use of an extinguishing fluid 16 compatible with each other and also compatible with the system and method that are also the objects of the present invention. Accordingly, the characteristics of each one applies to each other, barring due adaptations.

An example of a preferred embodiment having been described, it should be understood that the scope of the present invention encompasses other possible variations, being limited solely by the content of the accompanying claims, potential equivalents being included therein.

1. A system (1) to combat fires (60) in flammable liquids (65) in atmospheric tanks (50) comprising an extinguishing fluid source (10), a recondensation unit (11), a vaporization unit (12), a fluid transfer line (13) and an injector assembly (14) fluidly connected to each other, wherein the extinguishing fluid source (10) is arranged to supply an extinguishing fluid (16) to the system (1), the extinguishing fluid (16) being propelled and conducted along the fluid transfer line (13) until it reaches the injector assembly (14), the injector assembly (14) being positioned inside the atmospheric tank (50) and arranged so that the extinguishing fluid (16) is discharged inside the atmospheric tank (50) such that said extinguishing fluid (16) in liquid phase is immediately sublimated in gaseous phase in the midst of the flammable fluid (65) inside the tank (50) and emerges in the tank (50) when inserted in the tank (50).

2. The system to combat fires (60) in flammable liquids (65) in atmospheric tanks (50) according to claim 1, wherein the injector assembly (14) is positioned inside the atmospheric tank (50), being disposed on a lower portion of same.

3. The system to combat fires (60) in flammable liquids (65) in atmospheric tanks (50) according to claim 2, wherein the extinguishing fluid (16) is discharged into the atmospheric tank (50) in liquid phase, gaseous phase or mixtures thereof.

4. The system to combat fires (60) in flammable liquids (65) in atmospheric tanks (50) according to claim 3, wherein the extinguishing fluid (16) is comprised at least of CO2, the extinguishing fluid (16) being inert to the content of the atmospheric tank (50).

5. The system to combat fires (60) in flammable liquids (65) in atmospheric tanks (50) according to claim 4, wherein the injector assembly (14) is comprised of at least one injector (15) and at least one valve.

6. The system to combat fires (60) in flammable liquids (65) in atmospheric tanks (50) according to claim 5, wherein each injector (15) is positioned with a downward slant relative to a horizontal plane so as to control turbulence in the fluid inside the atmospheric tank (50).

7. The system to combat fires (60) in flammable liquids (65) in atmospheric tanks (50) according to claim 6, wherein each injector (15) can be positioned with a downward slant relative to the horizontal plane so as to control turbulence in the flammable fluid (65) inside the tank (50), wherein the downward vertical slant of each injector (15) is from 3° to 10°.

8. The system to combat fires (60) in flammable liquids (65) in atmospheric tanks (50) according to claim 7, wherein each injector (15) can be positioned with a slant towards the center of the atmospheric tank (50) and/or outward from the center of the atmospheric tank (50) in relation to a tangent of a concentric hypothetical circle to the walls of said tank, so as to accelerate the propagation of the extinguishing fluid inside said atmospheric tank (50).

9. The system to combat fires (60) in flammable liquids (65) in atmospheric tanks (50) according to claim 8, wherein each injector (15) can be positioned with a slant towards the center of the atmospheric tank (50) or outward from the center of the atmospheric tank (50), wherein the inward or outward slant of the center of the tank is up to 10°.

10. The system to combat fires (60) in flammable liquids (65) in atmospheric tanks (50) according to claim 9, wherein the fluid inside the atmospheric tank (50) is a liquid.

11. The system to combat fires (60) in flammable liquids (65) in atmospheric tanks (50) according to claim 10, wherein the extinguishing fluid source (10) is comprised of a storage tank (17), the vaporization unit (12) and the recondensation unit (11), wherein the gaseous CO2 of the extinguishing fluid (16) passes through the recondensation unit (11) where it is liquefied.

12. The system to combat fires (60) in flammable liquids (65) in atmospheric tanks (50) according to claim 11, wherein the extinguishing fluid (16) passes through the vaporization unit (12) such that pressure stabilization occurs when using said system to combat fires (60).

13. The system to combat fires (60) in flammable liquids (65) in atmospheric tanks (50) according to claim 12, wherein the extinguishing fluid (16) is comprised of CO2 in liquid state and CO2 in gaseous state, wherein said extinguishing fluid (16) is stored in both states in the storage tank (17) of the extinguishing fluid source (10).

14. The system to combat fires (60) in flammable liquids (65) in atmospheric tanks (50) according to claim 13, wherein the extinguishing fluid (16) is discharged into the atmospheric tank (50) at a ratio of 70% of CO2 in liquid state and 30% of CO2 in gaseous state, or variations of the biphasic composition of the jet.

15. The system to combat fires (60) in flammable liquids (65) in atmospheric tanks (50) according to claim 14, wherein the system is arranged to form a primary layer immediately above the surface of the flammable liquid (65) in flames in the tank (50), wherein the primary layer is comprised at least of CO2 coming from the extinguishing fluid (16), wherein the fire (60) is impacted by a turbulence generated by the emersion of the extinguishing fluid (16) which is wholly sublimated in the midst of the flammable fluid (65).

16. A method of combating fires (60) in flammable liquids (65) in atmospheric tanks (50), using an extinguishing fluid source (10), a recondensation unit (11), a vaporization unit (12), a fluid transfer line (13), and an injector assembly (14) fluidly connected to each other, said method comprising the steps of:
storing an extinguishing fluid (16) in the extinguishing fluid source (10);
extracting the extinguishing fluid (16) from the extinguishing fluid source (16);
conducting the extinguishing fluid (16) along the fluid transfer line (13);
discharging the extinguishing fluid (16) into the atmospheric tank (50).

17. The method of combating fires (60) in flammable liquids (65) in atmospheric tanks (50) according to claim 16, wherein the steps of extracting the extinguishing fluid (16) from the extinguishing fluid source (10) and conducting the extinguishing fluid (16) along the fluid transfer line (13) are performed by means of an application of pressure.

18. The method of combating fires (60) in flammable liquids (65) in atmospheric tanks (50) according to claim 17, wherein the step of discharging the extinguishing fluid (16) into the atmospheric tank (50) is performed by means of the injector assembly (14), the injector assembly (14) being positioned inside the atmospheric tank (50) and being disposed on a lower portion of same.

19. The method of combating fires (60) in flammable liquids (65) in atmospheric tanks (50) according to claim 18, wherein the step of discharging the extinguishing fluid (16) into the atmospheric tank (50) is performed such that the extinguishing fluid (16) emerges in the tank, the extinguishing fluid (16) being wholly sublimated in gaseous phase in the midst of the flammable fluid (65) and emerging inside the atmospheric tank (50).

20. The method of combating fires (60) in flammable liquids (65) in atmospheric tanks (50) according to claim 19, wherein the extinguishing fluid (16) is comprised at least of CO2, the extinguishing fluid being inert to the content of the atmospheric tank (50) and being discharged in the atmospheric tank (50) in liquid phase, gaseous phase or mixtures thereof in the step of discharging the extinguishing fluid (16) into the atmospheric tank (50).

21.-38. (canceled)
